(19) United States
(12) Patent Application Publication
(10) Pub. No.: US 2026/0298685 A1
(43) Pub. Date: Oct. 1, 2026

(54) VORTEX METER WITH HYDROGEN GETTER MODULE

(71) Applicant: Micro Motion, Inc., Boulder, CO (US)

(72) Inventor: Jeffry Duane Foster, St. Louis Park, MN (US)

(21) Appl. No.: 19/096,417

(22) Filed: Mar. 31, 2025

(51) Int. Cl. G01F 15/12; G01F 1/32; G01F 15/00

(52) U.S. Cl. CPC G01F 15/125; G01F 1/32; G01F 15/005; G01F 15/006

(57) ABSTRACT

A vortex flowmeter measures process fluid flow. The vortex flowmeter includes a conduit that carries the process fluid. A sensing device is housed in a cavity of a sensor housing that is coupled to the conduit. A flexure is disposed in a portion of the conduit. The flexure is configured to isolate the process fluid in the conduit from the sensing device and is coupled to the sensing device. A hydrogen getter module is connected to the cavity and configured to remove hydrogen from the cavity to protect the sensing device.

### BACKGROUND

The present invention relates to vortex flowmeters. More specifically, the invention relates to vortex flowmeters for use with a pressurized process fluid in high temperature hydrogen rich applications, such as hydrocarbon applications.

Vortex flowmeters are commonly used in industrial processes to measure a flow of a process fluid, such as slurries, liquids, vapors and gases of chemicals, petroleum, pharmaceuticals, food, and other fluid-type plant processes. Typically, vortex flowmeters utilize a shedding bar placed in a fluid flow to cause or generate vortices on opposite sides of the shedding bar. The frequency of vortex shedding for a shedding bar is directly is proportional to the velocity of flow in the process fluid. Therefore, vortex flowmeters sense the fluctuating pressures caused by the generated vortices to determine the velocity of the process fluid flow. Example vortex flowmeter implementations can be found in U.S. Pat. No. 4,926,695 to Rosemount Inc. of Eden Prairie, Minn. on May 2, 1990, U.S. Pat. No. 5,343,762 to Rosemount Inc. of Eden Prairie, Minn. on Sep. 6, 1994.

Vortex sensors made from certain piezo materials have been found to fail in the presence of hydrogen. Vortex flowmeters operating in challenging high temperature hydrogen rich applications, such as hydrocarbon applications, are susceptible to sensor failure due to hydrogen permeation. Aside from these sensor failure issues caused by exposure to hydrogen, vortex flowmeters can be particularly useful in high temperature applications, high hydrogen refining applications, and bio-refining applications. This is due to the fact that vortex flowmeters do not plug, are immune to high temperatures, are not subject to erosion in the same manner as differential pressure sensors.

The discussion above is merely provided for general background information and is not intended to be used as an aid in determining the scope of the claimed subject matter.

### SUMMARY

Embodiments of the disclosure are directed to a vortex flowmeter that measures process fluid flow. The vortex flowmeter includes a conduit that carries the process fluid. A sensing device is housed in a cavity of a sensor housing that is coupled to the conduit. A flexure is disposed in a portion of the conduit. The flexure is configured to isolate the process fluid in the conduit from the sensing device and is coupled to the sensing device. A hydrogen getter module is coupled through a passage to the cavity and is configured to remove hydrogen from the cavity to protect the sensing device. A pathway extends from the cavity to an outer surface of the sensor housing. Disposed in the pathway is preferably a device extending to an outer surface of the meter body, the device is configured for use in determining the presence of any process fluid in the cavity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a perspective view of a flowmeter under one embodiment, including a diagrammatic illustration of a replaceable hydrogen getter module.

FIG. 2 is an enlarged and exploded partial view of the flowmeter illustrated in FIG. 1.

FIG. 3 is a partial sectional view of the flowmeter illustrated in FIG. 1, including a diagrammatic illustration of the replaceable hydrogen getter module.

FIGS. 4A and 4B are front and top views of an embodiment of the flowmeter illustrated in FIG. 1 including a replaceable hydrogen getter module.

FIG. 5 is a plot illustrating results of hydrogen permeation tests and showing beneficial results achieved with inclusion of a hydrogen getter module.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

Embodiments described herein are directed to vortex flowmeters, which are used to measure process fluid flow. Vortex flowmeters operate by utilizing a shedding bar placed in a process fluid flow that causes or generates vortices alternately on opposite sides of the shedding bar. The shedding bar causes variations in pressure on either of its sides. The frequency of vortices formed by the shedding bar is directly proportional to the velocity of flow in the process fluid. Replaceable hydrogen getter modules of the vortex flowmeters trap hydrogen to reduce hydrogen permeation which can cause sensor failure especially when the flowmeters are used in high temperature hydrogen rich hydrocarbon application.

A significant source of failure for vortex sensors can be a relatively small number of high hydrogen refining applications. This high failure rate has reduced the adoption of vortex meters in these applications, even though in these applications vortex meters are far superior. Vortex meters never plug, and require no zeroing, flush fluids or any other ancillary equipment.

With hydrogen permeation, hydrogen dissociates into atoms and travels either via interstitial spaces or thru vacancy mechanisms across stainless-steel walls. In the presence of hydrogen, the sodium bismuth titanate piezo elements can degrade. Bismuth will start to form a ball on the surface of the piezo element when left in the presence of high temperature hydrogen. Simultaneously, the bismuth will form an electrical path through the piezo element. Once that happens, the impedance falls to zero and the piezo element is unable to generate charge on opposite sides, rendering it useless as a sensing device. Disclosed embodiments provide a flow measurement device for challenging high temperature hydrogen rich hydrocarbon applications which are susceptible to sensor failure due to hydrogen permeation. These embodiments trap the hydrogen in a container that is periodically replaced. This allows the vortex flowmeter to run for years without a sensor replacement.

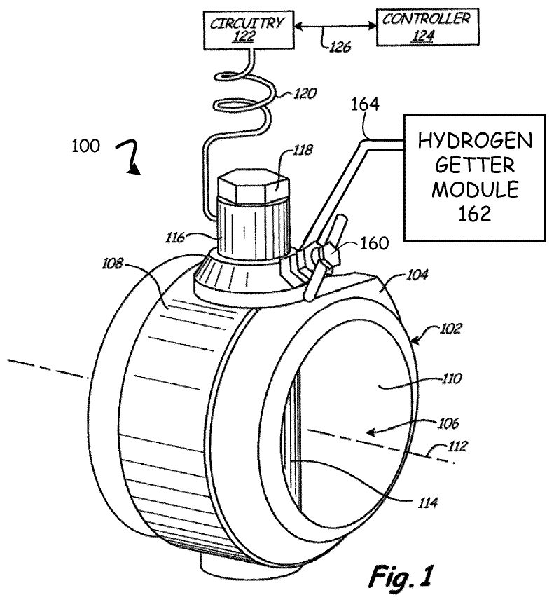

FIG. 1 illustrates a partial view of a flowmeter 100 under one embodiment. Flowmeter 100 includes a conduit 102 having a conduit wall 104 surrounding a bore 106. Conduit 102 includes an exterior surface 108 and an interior surface 110. Bore 106 carries a process fluid, which can be a liquid or a gas, generally along a conduit axis 112. A shedding bar 114 is positioned in conduit 102 to act as a vortex-generating obstruction for the process fluid. Typically, shedding bar 114 includes an upstream extremity, a downstream extremity and an intermediate portion that couples the upstream extremity to the downstream extremity.

Positioned on exterior surface 108 of conduit 102 includes a sensor housing 116. Sensor housing 116 is configured to house a sensing device having a sensor body (not illustrated in FIG. 1) that can be removed via sensor nut 118. The sensing device housed in sensor housing 116 generates an output and communicates the output via lead 120 to circuitry 122. Typically, circuitry 122 is adapted to communicate the output to a controller 124 via a communication link 126 (which can be a two-wire, three-wire or four-wire loop or a wireless communication link).

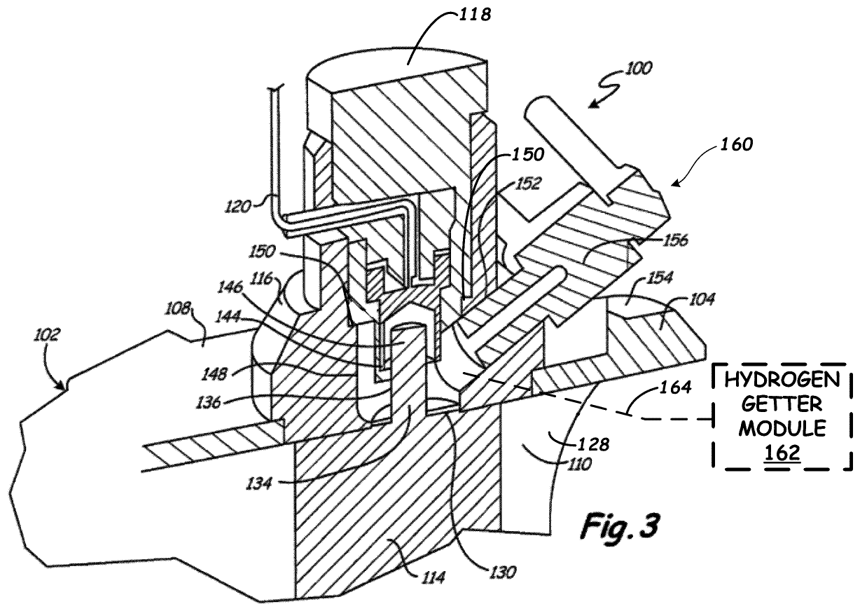

Flowmeter 100 also includes a critical process access (CPA) valve 160 which provides safe access to a sensor cavity for use in verifying that there is no process fluid present, enabling maintenance, or calibration, without disrupting the process. As shown diagrammatically in FIG. 1, flowmeter 100 also includes replaceable hydrogen getter module 162. By adding a branch connection 164 upstream of the valve 160, the hydrogen getter module 162 is plumbed or connected into the sensor cavity, described further below with reference to FIG. 3, to allow for both the removal of hydrogen from the cavity and for the safe replacement of the hydrogen getter material either by replacement of a module itself, or the hydrogen getter media, depending on the preferred construction of the module 162 that is chosen.

Hydrogen getter module 162 uses media specifically designed to capture hydrogen and bind it to a solid. Examples of hydrogen getters are used in many different applications from electronics to nuclear waste handling equipment. In some example embodiments, hydrogen getter module 162 utilizes a polymeric sheet getter material to capture hydrogen due in part to the lower cost of this hydrogen getter material. In other embodiments, metal hydrogen getter material, such as palladium plated on titanium, is used. In still other embodiments, the hydrogen getter material can be a powder. Disclosed embodiments are not limited to a particular hydrogen getter material. The hydrogen getter material is packaged into a module to ensure no loss of secondary process containment if the primary process seal fails. This module 162 is preferably a replaceable module, allowing the easy refreshing of the hydrogen getter material and providing a flowmeter which can operate for years without the need for repair or flowmeter replacement.

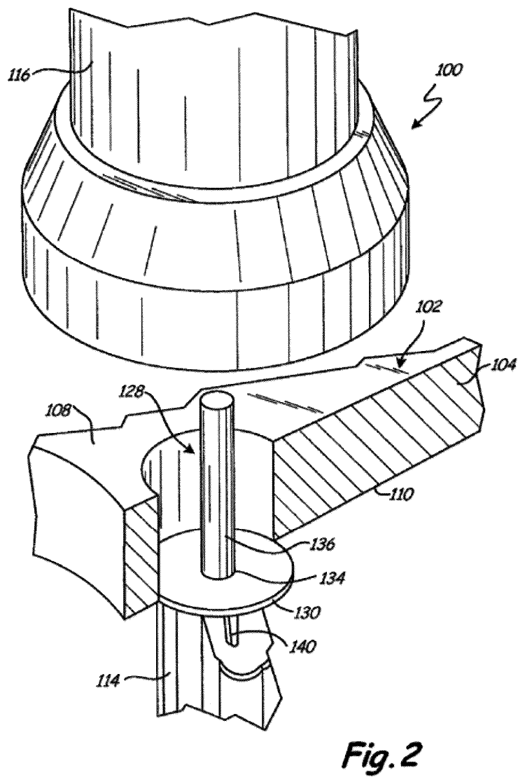

FIG. 2 is an enlarged and exploded partial view of flowmeter 100 illustrated in FIG. 1. As illustrated in FIG. 2, flowmeter 100 includes a partial view of sensor housing 116 exploded from conduit wall 104. Conduit wall 104 includes a wall region of reduced thickness that is commonly referred to as a flexure 130 or as the intermediate portion of shedding bar 114 as discussed above. Flexure 130 flexes in response to disturbances or vortices within the process fluid created by process fluid flow around the upstream extremity (discussed above) to promote motion of at least a portion of the downstream extremity (discussed above).

Between an exterior surface 108 of conduit wall 104 and flexure 130, the flowmeter includes a hole 128 where flexure 130 is disposed for communication with the process fluid carried by conduit 102. The upstream extremity and the downstream extremity of shedding bar 114 are also in communication with process fluid carried by conduit 102. Flexure 130 is coupled to the downstream extremity or pivoting member 140 extending from flexure 130 into bore 106 of conduit 102. The fluctuating fluid pressures that act on the upstream extremity of shedding bar 114 moves the downstream extremity or pivoting member 140 in response to the fluctuating pressures. A post 136 couples flexure 130 to a sensing device (not illustrated in FIG. 2) housed in sensor housing 116.

FIG. 3 is a partial sectional view of flowmeter 100 illustrated in FIG. 1. As illustrated in FIG. 3, flowmeter 100 includes conduit 102 having conduit wall 104, hole 128 in conduit wall 104, sensor housing 116, lead 120, shedding bar 114, flexure 130 and surface or post 136. Sensor housing 116 is configured to house a sensing device 144. Sensing device 144 is coupled to flexure 130 by post 136 such that sensing device 144 is isolated from the process fluid in conduit 102. In particular, sensing device 144 is sealed to post 136 at an end opposite an end coupled to flexure 130. In one embodiment, a C-ring 150 seals the sensor to the sensor housing forming a sealed volume in cavity 148. The sensing device engages with the post 136 via an interference fit using a diaphragm on the sensor. With the coupling of sensing device 144 to post 136 and flexure 130, sensing device 144 is able to sense the motion of pivoting member 140 (illustrated in FIG. 2) and therefore the fluctuating pressures in conduit 102. Sensing device 144 generates an output indicative of the sensed motion and communicates the sensed motion to circuitry 122 (FIG. 1) via lead 120 and ultimately to controller 124 (FIG. 1) via communication link 126 (FIG. 1).

Sensing device 144 is housed in a cavity 148 of sensor housing 116. Cavity 148 is useful in the event that sensing device 144 fails. Since sensing device 144 is isolated from the process fluid in conduit 102, sensing device 144 can be removed and replaced without having to depressurize conduit 102. To remove sensing device 144, sensor nut 118 is removed, which holds c-ring seal 150 and sensing device 144 in place. However, replacing sensing device 144 while conduit 102 is under pressure can be unsafe. In the event that sensing device 144 fails, it is impossible to know if flexure 130 that is in communication with the process fluid and pivoting member 140 has also failed. Therefore, it would be useful determine whether flexure 130 is intact before replacing sensing device 144.

Under one embodiment and as illustrated in FIG. 3, flowmeter 100 includes a pathway 152. Pathway 152 extends from cavity 148 to an outer surface 154 of sensor housing 116. Flowmeter 100 includes a valve body 156 disposed in pathway 152. Valve body 156 of CPA valve 160 is configured in a closed position (normally shut) during normal operation of flowmeter 100. However, valve body 156 is configured in an opened position for detecting whether at least some of the process fluid is being improperly contained in cavity 148. In other words, during the process of changing sensing device 144, a user can safely open the valve body 156 to determine if process fluid exists in cavity 148. If process fluid is detected in cavity 148, then the user would shut the valve body 156 and proceed with depressurizing conduit 102 to change sensing device 144. Fluid in cavity 148 means that flexure 130 is leaking and has also failed. If, however, process is fluid is not detected in cavity 148, then the user can proceed with changing sensing device 144 without needing to depressurize conduit 102. Again shown diagrammatically in FIG. 3, a branch connection 164 to cavity 148 or pathway 152 connects hydrogen getter module 162 to the cavity to capture hydrogen and prevent hydrogen permeation damage to the sensor. While the embodiment illustrated in FIG. 3 includes CPA valve 160, the CPA valve is not required in some embodiments having a hydrogen getter module 162.

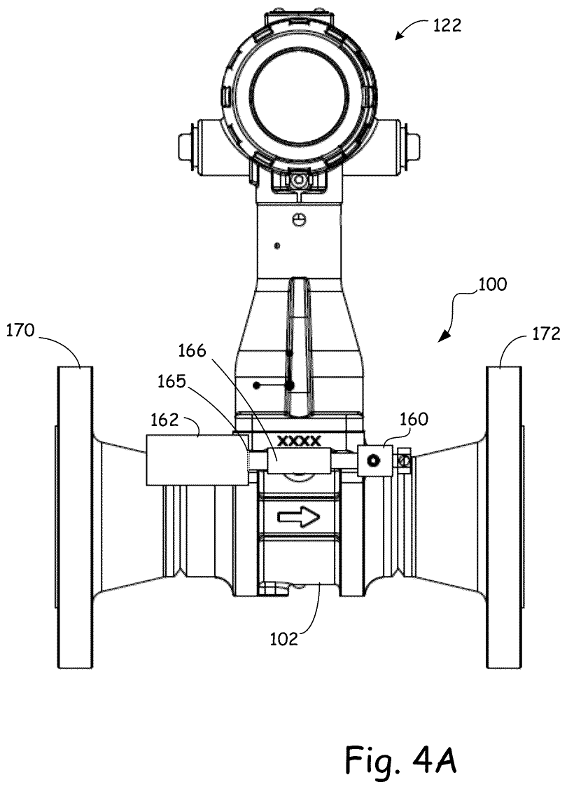

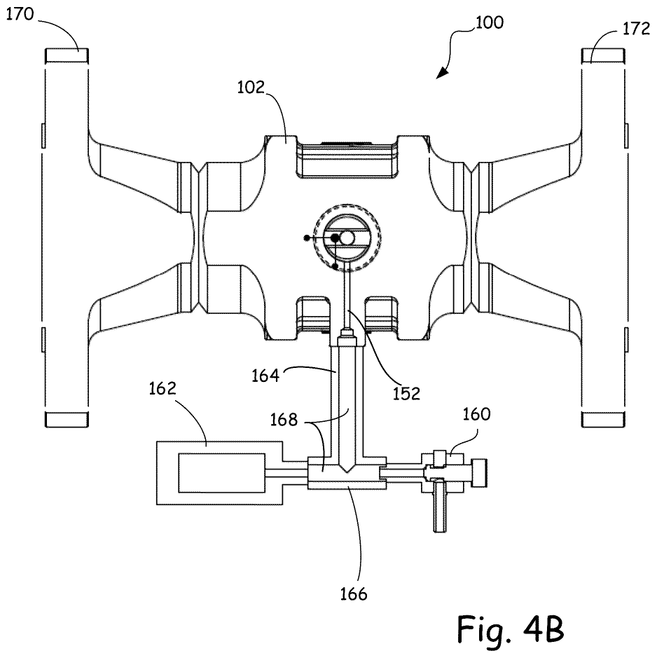

FIGS. 4A and 4B are front and top view illustrations of vortex flowmeter 100 coupled between two flanged connectors 170 and 172. FIGS. 4A and 4B show hydrogen getter module 162 in a cartridge or container form which can be removed, for example by being unscrewed from branch connection 164, for replacement. In the embodiment illustrated in FIGS. 4A and 4B, branch connection 164 is a T-shaped connector having portion 166 which connects getter module 162 and valve 160 through an interior conduit or pathway 168 to cavity 148 or pathway 152. In some embodiments, the hydrogen getter module includes a seal 165 (shown in FIG. 4A), such as an O-ring or other type of seal, to aid in sealing the hydrogen getter material and thereby allowing the module to be replaceable. While branch connection 164 is shown partially exterior to the sensor housing, in other embodiments, the branch connection 164 is entirely internal to the sensor housing or to the pathway 152 used by valve body 156 of valve 160. In such embodiments, the branch connection is a passage coupling the hydrogen getter module to the cavity. Also, as described above, in some embodiments a hydrogen getter module is included without the CPA valve and valve body. In the illustrated embodiment, the hydrogen getter module 162 is threaded onto portion 166 of connection 164, and thereby coupled to pathway 152. Connector 166 can in other embodiments utilize other pathways to the sensor cavity 148 such that hydrogen from the sensor cavity travels to the hydrogen getter module 162 and is captured. As noted, the disclosed embodiments trap the hydrogen in a container (getter module 162) that is periodically replaced. This allows the vortex flowmeter to run for years without a sensor replacement.

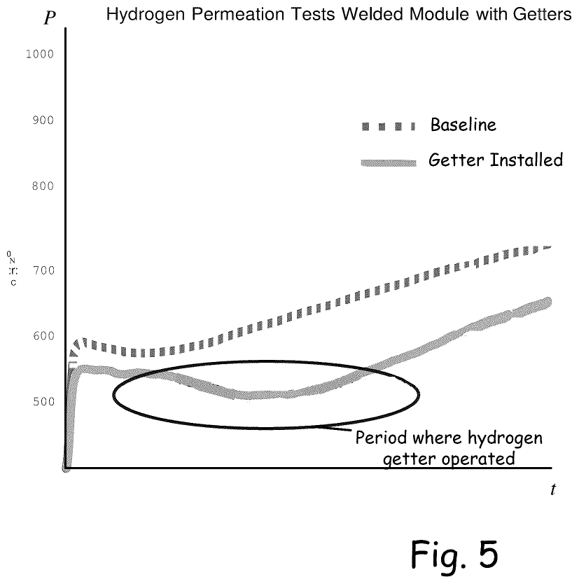

FIG. 5 is a graph illustrating the effects of hydrogen permeation without the hydrogen getter module (Baseline) and with the hydrogen getter module (Getter Installed) in a test of an example embodiment. To test this method of hydrogen control, the partial pressure of hydrogen on the sensor side of a meter was measured. On the process side of the meter, a 50% hydrogen/argon weld gas at 500 psi was applied. Within a short period of time, the pressure on the sensor side started to climb. In the test, the polymeric getter significantly increased the amount of time recorded before pressures started to rise in the sensor cavity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A vortex flowmeter for measuring process fluid flow comprising:
a conduit for carrying process fluid;
a sensing device housed in a cavity of a sensor housing coupled to the conduit;
a flexure disposed in a portion of the conduit and coupled to the sensing device, the flexure configured to isolate the process fluid in the conduit from the sensing device; and
a hydrogen getter module coupled through a passage to the cavity and configured to remove hydrogen to protect the sensing device housed in the cavity.

2. The vortex flowmeter of claim 1, and further comprising:
a pathway extending from the cavity to an outer surface of the sensor housing; and
a valve body disposed in the pathway.

3. The vortex flowmeter of claim 2, wherein the passage coupling the hydrogen getter module to the cavity includes the pathway extending from the cavity to the outer surface of the sensor housing.

4. The vortex flowmeter of claim 1, wherein the hydrogen getter module contains a material that absorbs hydrogen to remove the hydrogen from an atmosphere in the cavity.

5. The vortex flowmeter of claim 4, wherein the material that absorbs hydrogen is a polymeric getter material.

6. The vortex flowmeter of claim 1, wherein the valve body comprises a critical process access valve configured to provide access for verifying primary pressure containment within the sensor housing.

7. The vortex flowmeter of claim 6, wherein the valve body is configured in a closed position during normal operation of the vortex flowmeter, and wherein the valve body is configured in an open position for detecting whether some of the process fluid is being improperly contained in the cavity.

8. The vortex flowmeter of claim 1, wherein the hydrogen getter module is configured to be removed for replacement.

9. The vortex flowmeter of claim 8, wherein the hydrogen getter module includes a seal to protect a hydrogen getter material inside the hydrogen getter module.

10. The vortex flowmeter of claim 1, further comprising a post that couples the flexure to the sensing device.

11. A vortex flowmeter for measuring process fluid flow comprising:
a conduit for carrying a process fluid along a conduit axis, the conduit having an area of reduced thickness between exterior and interior surfaces of the conduit;
a shedding bar disposed in the conduit and including a pivoting member that fluctuates in response to fluctuation in pressures;
a sensing device housed in a cavity of a sensor housing coupled to the conduit, wherein the sensing device is isolated from the process fluid by the area of reduced thickness of the conduit; and
a hydrogen getter module coupled through a passage to the cavity and configured to remove hydrogen from the cavity to protect the sensing device housed in the cavity.

12. The vortex flowmeter of claim 11, and further comprising:
a pathway extending from the cavity to an outer surface of the sensor housing; and
a valve body disposed in the pathway;
wherein the valve body is configured in a closed position during normal operation of the vortex meter, and wherein the valve body is configured in an open position for detecting whether some of the process fluid is being improperly contained in the cavity.

13. The vortex flowmeter of claim 12, wherein the passage coupling the hydrogen getter module to the cavity includes the pathway extending from the cavity to the outer surface of the sensor housing.

14. The vortex flowmeter of claim 11, wherein the hydrogen getter module contains a material that absorbs hydrogen to remove the hydrogen from an atmosphere in the cavity.

15. The vortex flowmeter of claim 14, wherein the material that absorbs hydrogen is a polymeric getter material.

16. The vortex flowmeter of claim 14, wherein the material that absorbs hydrogen is a metal.

17. The vortex flowmeter of claim 16, wherein the metal comprises palladium plated on titanium.

18. The vortex flowmeter of claim 14, wherein the material that absorbs hydrogen is a powder.

19. The vortex flowmeter of claim 11, wherein the hydrogen getter module includes a seal to protect a hydrogen getter material inside the hydrogen getter module to configure the hydrogen getter module as replaceable.

20. The vortex flowmeter of claim 11, wherein the hydrogen getter module is configured to be removed for replacement.
